(19) United States
(12) Patent Application Publication
(10) Pub. No.: US 2015/0063773 A1
(43) Pub. Date: Mar. 5, 2015

(54) OPTICAL FIBER CABLE MANAGEMENT APPARATUSES WITH STORAGE HUB COMPONENTS

(71) Applicant: CORNING OPTICAL COMMUNICATIONS LLC, Hickory, NC (US)

(72) Inventors: Hubert Blair Beamon, Watauga, TX (US); Boyd Grant Brower, Keller, TX (US); William Julius McPhil Giraud, Azle, TX (US); Diana Rodriguez, Fort Worth, TX (US)

(21) Appl. No.: 14/470,269

(22) Filed: Aug. 27, 2014

Related U.S. Application Data
(60) Provisional application No. 61/871,941, filed on Aug. 30, 2013.

(51) Int. Cl. G02B 6/44

(52) U.S. Cl. CPC G02B 6/4457
USPC 385/135

(57) ABSTRACT

A storage hub component for hanging optical fiber cable that includes a mounting base configured to be mounted within a cable storage housing. A hanging projection extends outwardly from the mounting base. The hanging projection is sized to receive loops of optical fiber cable thereon. A cable retaining feature includes a flexible retaining tab extending outwardly from a peripheral surface of the hanging projection. The flexible retaining tab is configured to bend upon contact with the optical fiber cable.

### RELATED APPLICATIONS

This application claims the benefit of priority under 35 U.S.C. §119 of U.S. Provisional Application 61/871,941 filed on Aug. 30, 2013, the content of which is relied upon and incorporated herein by reference it its entirety.

### BACKGROUND

1. Field of Disclosure

The disclosure relates generally to cable management systems, and more particularly, to optical fiber cable management apparatuses with storage hub components.

2. Technical Background

Optical fiber management systems are commonly used to store slack optical fiber within a cable storage housing. Various cable managing arrangements, such as hanging pegs have been used on which to hang the slack optical fiber. These cable managing arrangements may include hard cable retaining structures that extend in various directions. As the cable housings become more dense with an increasing number of cable managing arrangements to hold more optical fiber, the hard cable retaining structures become increasingly difficult to work around.

### SUMMARY

One embodiment of the disclosure relates to a storage hub component for hanging optical fiber cable that includes a mounting base configured to be mounted within a cable storage housing. A hanging projection extends outwardly from the mounting base. The hanging projection is sized to receive loops of optical fiber cable thereon. A cable retaining feature includes a flexible retaining tab extending outwardly from a peripheral surface of the hanging projection. The flexible retaining tab is configured to bend upon contact with the optical fiber cable.

In another embodiment, an optical fiber cable management apparatus includes a cable storage housing. A plurality of storage hub components is mounted within the cable storage housing. Each storage hub component includes a mounting base configured to be mounted within the cable storage housing. A hanging projection extends outwardly from the mounting base. The hanging projection is sized to receive loops of optical fiber cable thereon. A cable retaining feature includes a flexible retaining tab extending outwardly from a peripheral surface of the hanging projection. The flexible retaining tab is configured to bend upon contact with the optical fiber cable.

In another embodiment, a method of managing optical fiber cable using a cable management apparatus including a cable storage housing and multiple storage hub components mounted within the cable storage housing is provided. The method includes providing a storage hub having a hanging projection with a flexible retaining tab extending outwardly from a peripheral surface of the hanging projection. The flexible retaining tab is bent from an initial, upright position toward the hanging projection providing increased spacing to place the optical fiber cable about the hanging projection.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a storage hub component according to one or more embodiments shown and described herein;

FIG. 2 is an exploded view of the storage hub component of FIG. 1 illustrating storage hub component portions;

FIG. 3 is a perspective, exploded view of one of the storage hub component portions of FIG. 2; and

FIG. 4 illustrates a perspective, assembled view of the storage hub component portion of FIG. 3;

FIGS. 5-8 illustrate operation of the storage hub component of FIG. 1 according to one or more embodiments described herein;

FIG. 9 illustrates an optical fiber cable management apparatus that includes a cable storage housing and multiple ones of the storage hub components of FIG. 1 mounted therein according to one or more embodiments described herein;

FIGS. 10 and 11 illustrate operation of the optical fiber cable management apparatus of FIG. 9 according to one or more embodiments described herein;

FIGS. 12A-12C illustrate another storage hub component according to one or more embodiments described herein;

FIGS. 13A-13C illustrate another storage hub component according to one or more embodiments described herein; and

FIGS. 14A-14C illustrate another storage hub component according to one or more embodiments described herein.

### DETAILED DESCRIPTION

Embodiments described herein generally relate to optical fiber cable management apparatuses with storage hub components that can be used in storing optical fiber cables. The storage hub components may be arranged within a cable storage housing in a side-by-side fashion and include flexible cable retaining features that are used in retaining the optical fiber cables. As will be described below, the flexible cable retaining features can bend to facilitate handling of the optical fiber cables within the cable storage housing.

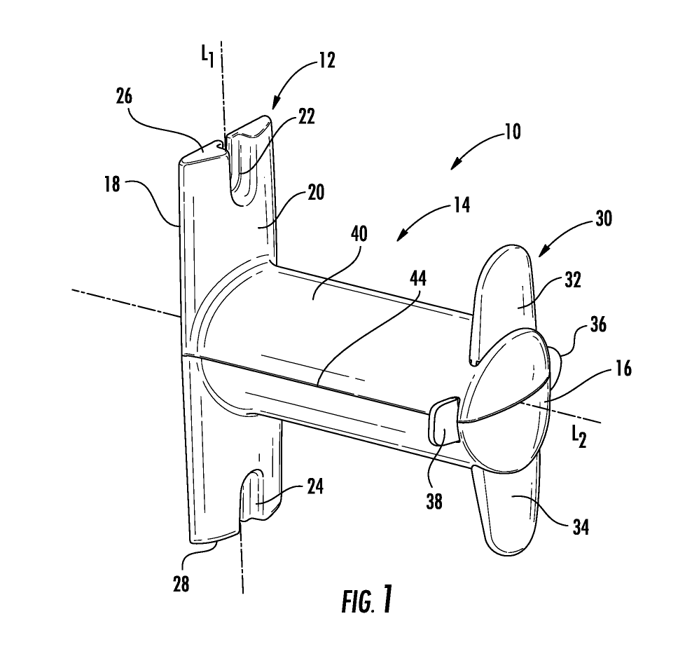

Referring to FIG. 1, a storage hub component 10 can be used in storing optical fiber cable and includes a mounting base 12 and a hanging projection 14 extending outwardly therefrom to a distal end 16 in a cantilevered arrangement. The mounting base 12 has a long axis L₁ that extends in a direction generally perpendicular to a long axis L₂ of the hanging projection 14 and includes a substantially flat side 18 (to facilitate mounting flush to a flat surface) and a somewhat rounded side 20, opposite the flat side 18 from which the hanging projection 14 extends. In some embodiments, side 20 may also be flat. Hanging features 22 and 24 (e.g., notches or openings) are provided at respective ends 26 and 28 of the mounting base 12. The hanging features 22 and 24 are sized and arranged to engage mating hanging features, such as fasteners to mount the storage hub component 10 within a cable storage housing.

The hanging projection 14 extends outwardly from the rounded side 20 in a perpendicular fashion. While the hanging projection 14 is illustrated as extending outwardly from the mounting base 12 perpendicularly, or in other words, generally at 90 degrees with respect to the long axis L₁, the hanging projection 14 may extend outwardly from the mounting base 12 at a different angle less than or greater than 90 degrees. The hanging projection 14 is circular in cross-section and has a diameter that is suitable for maintaining a minimum bend radius for any optical fiber cable position thereabout. Cross-sectional shapes other than circular may be used, such as, rectangular and various polygonal shapes.

A cable retaining feature 30 is located at the distal end 16 of the hanging projection 14. As shown, the cable retaining feature 30 may be at least partially spaced proximally from the distal end 16. In some embodiments, the cable retaining feature 30 is located within 10 percent of the length of the hanging projection 14 from the distal end 16. The cable retaining feature 30 includes primary retaining tabs 32 and 34 and secondary retaining tabs 36 and 38. All of the retaining tabs 32, 34, 36 and 38 extend outwardly from a peripheral surface 40 of the hanging projection 14. The primary retaining tabs 32 and 34 extend outwardly, away from each other at opposite sides of the hanging projection 14. As illustrated, the primary retaining tabs 32 and 34 extend parallel to the long axis L₁ of the mounting base 12. The secondary retaining tabs 36 and 38 extend outwardly, away from each other at opposite sides of the hanging projection 14 (e.g., spaced about 90 degrees from the primary retaining tabs 32 and 34). The secondary retaining tabs 36 and 38 are illustrated as extending perpendicular to the long axis L₁ and the primary retaining tabs 32 and 34, however, other angles are possible. Additionally, while four retaining tabs are illustrated, there may be more or less than four retaining tabs. The secondary retaining tabs 36 and 38, in some embodiments, have one or more width or height dimensions that are less than the width or height dimensions of the primary retaining tabs 32 and 34. As will be described in greater detail below, the cable retaining feature 30 including the retaining tabs 32, 34, 36 and 38 is used to retain optical fiber cable on the hanging projection 14.

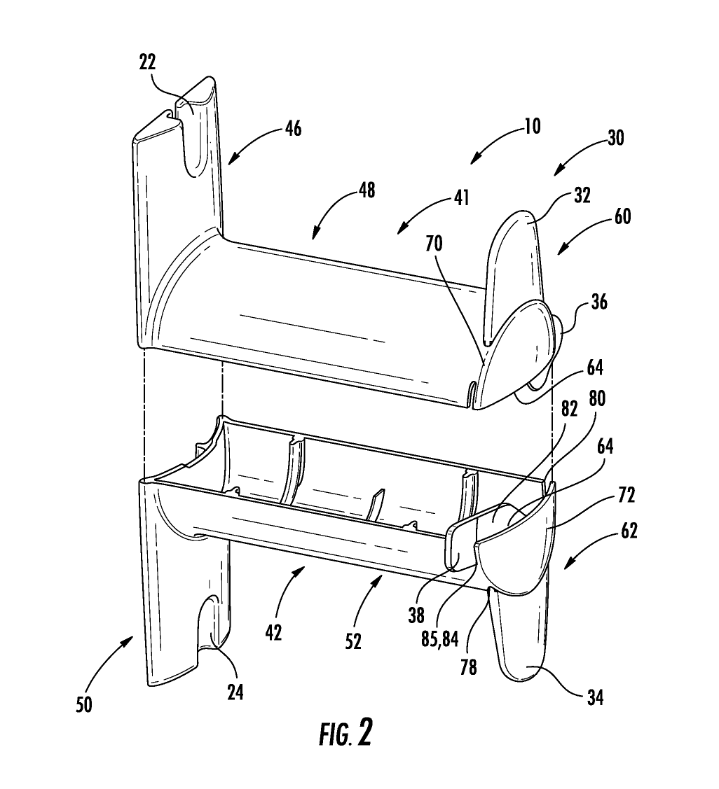

Referring also to FIG. 2, storage hub component 10 may be formed of storage hub component portions 41 and 42. The storage hub component portions 41 and 42 may each form about half of the storage hub component 10 and may be connectable along a part line 44 (FIG. 1) that extends along with the long axis L₂ of the hanging projection 14. Referring particularly to FIG. 2, the storage hub component portion 41 includes a mounting base portion 46 that is formed integrally (e.g., integrally molded) with a hanging projection portion 48. The mounting base portion 46 includes the hanging feature 22 and the hanging projection portion 48 includes the retaining tabs 32 and 36 extending outwardly therefrom as described above. Similarly, the storage hub component portion 42 includes a mounting base portion 50 that is formed integrally (e.g., integrally molded) with a hanging projection portion 52. The mounting base portion 50 includes the hanging feature 24 and the hanging projection portion 52 includes the retaining tabs 34 and 38 extending outwardly therefrom as described above.

Referring still to FIG. 2 and also to FIG. 3, the cable retaining feature 30 may include cable retaining members 60 and 62. The cable retaining member 60 includes the retaining tabs 32 and 36 and the cable retaining member 62 includes the other retaining tabs 34 and 38. Referring particularly to FIG. 3, only cable retaining member 60 is shown for simplicity. Both cable retaining members 60 and 62 may include the same or similar features. The cable retaining members 60 and 62 may include a body 64 that connects the primary retaining tabs 32, 34 to their respective secondary retaining tabs 36 and 38. The body 64 includes a first portion 66 that is connected to the primary retaining tab 32, 34 with a lip 68 that engages a closed edge portion 70, 72 located between tab receiving slots 74 and 76 and 78 and 80. The body 64 includes a second portion 82 that extends outwardly from the first portion 66 at about a 90 degree angle that is connected to the secondary retaining tab 36 and 38. The second portion 82 may engage an edge 84 (FIG. 4) of the tab receiving slots 83 and 85 to retain the cable retaining members 60 and 62 in the positions illustrated by FIGS. 1 and 2.

In some embodiments, the cable retaining members 60 and 62 including their bodies 64 and retaining tabs 32, 34, 36 and 38 may be formed as a single piece and of the same material, for example using a molding process. In some embodiments, the retaining tabs 32, 34, 36 and 38 may be formed of a different material than the material forming the bodies 64. For example, the retaining tabs 32, 34, 36 and 38 may be formed of a rubber, plastic, foamed material, etc. that is more flexible than the material (e.g., a harder plastic, metal, etc.) forming the bodies 64. In some embodiments, the retaining tabs 32, 34, 36 and 38 may be overmolded onto the bodies 64 or otherwise formed separately and then attached to the bodies 64.

As can be seen by FIG. 3, the cable retaining members 60 and 62 may have stepped out portions 90 and 92 where the retaining tabs 32, 34, 36 and 38 meet the bodies 64. Referring to the cable retaining member 60, for example, the stepped out portion 90 provides a thickness T₁ of the primary retaining tab 32 that is greater than a thickness T_{b} of the body 64 adjacent the primary retaining tab 32. In some embodiments, the thickness of the primary retaining tab 32 may decrease or may otherwise change along a dimension H₁ of the primary retaining tab 32. For example, the thickness of the primary retaining tab 32 may decrease from the stepped out portion 90 to a tip 96 of the primary retaining tab 32. Likewise, the stepped out portion 92 provides a thickness T₂ of the secondary retaining tab 36 that is greater than a thickness T_{b} of the body 64 adjacent the secondary retaining tab 36. In some embodiments, the thickness of the secondary retaining tab 36 may decrease or may otherwise change along a dimension H₂ of the secondary retaining tab 36. For example, the thickness of the secondary retaining tab 36 may decrease from the stepped out portion 92 to a tip 98 of the secondary retaining tab 36. In other embodiments, the thicknesses of one or both the primary retaining tab 32 and the secondary retaining tab 36 may not change and may be substantially the same along the heights H of the retaining tabs 32 and 36.

The thicknesses T₁ of the primary retaining tabs 32 and 34 may be narrower at the tips 96 for facilitate their passage through the receiving slots 74 and 78 (FIG. 2). In some embodiments, for example, the thicknesses T₁ of the primary retaining tabs 32 and 34 at their tips 96 may be less than a width of the receiving slots 74 and 78. This can facilitate passage of at least the tip portions of the primary retaining tabs 32 and 34, which can then allow the user to grasp the tips 96 and pull the remaining primary retaining tabs 32 and 34 through the receiving slots 74 and 78.

Referring to FIG. 4, the primary retaining tab 32 is illustrated as being pulled through the receiving slot 74 such that the stepped out portion 90 engages the peripheral surface 40 around the receiving slot 74 due to the increased thickness T₁ of the primary retaining tab 32 that is greater than the width of the receiving slot 74. Such an arrangement can inhibit unintended removal of the retaining member 60 back through the retaining slot 74 during assembly or use. Additionally, while the primary retaining tab 32 is pulled through the receiving slot 74, the second portion 82 of the body 64 may be received within receiving slot 83.

Referring back to FIG. 2, the primary retaining tab 34 of the retaining member 62 may be connected to the hanging projection portion 52 in a fashion similar to that described above by pulling the primary retaining tab 34 through the tab receiving slot 78. The stepped out portion 90 can engage the peripheral surface 40 around the receiving slot 78 due to the increased thickness T₁ of the primary retaining tab 34 that is greater than the width of the receiving slot 78. While the primary retaining tab 34 is pulled through the receiving slot 78, the second portion 82 of the body 64 may be received within receiving slot 85. As can be seen by FIG. 2, the second portions 82 of the bodies 64 may only be partially received within the receiving slots 83 and 85. The other of the hanging projection portion 48 or 52 may include receiving slots 76 and 80 that receive the second portions 82 that extend outwardly beyond their respective receiving slots 76 and 80 when the storage hub component portions 41 and 42 are assembled together (FIG. 1).

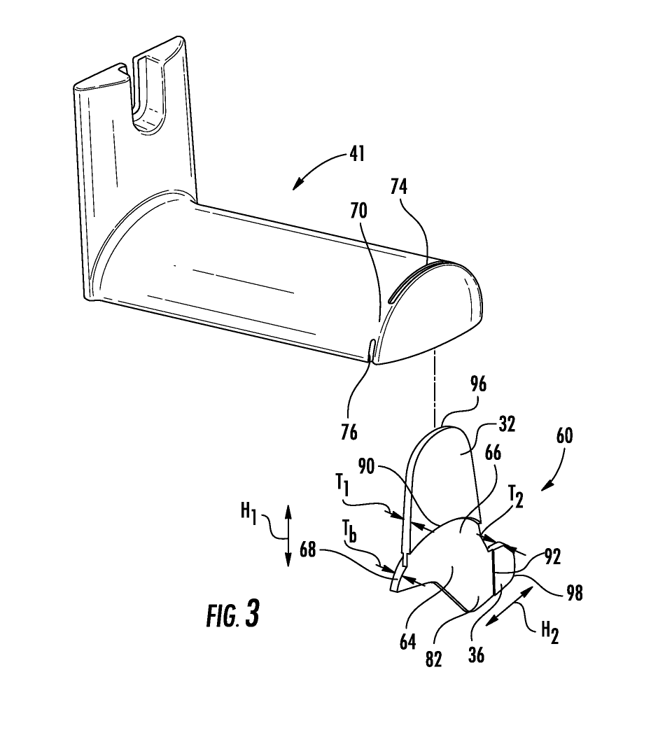

FIGS. 5 and 6 illustrate operation of the storage hub component 10 and cable retaining feature 30, once the storage hub component portions 41 and 42 are assembled. In FIG. 5, a bent optical fiber cable 110 is illustrated being moved onto the hanging projection 14 of the storage hub component 10. As will be discussed in greater detail below, the storage hub component 10 may be one of an array or multiple storage hub components that are located side-by-side within a cable storage housing and space may be limited. As the optical fiber cable 110 is moved by the cable retaining feature 30 in the direction of arrow 112, the optical fiber cable 110 may engage or otherwise come into contact with any one of the primary tabs 32, 34 or secondary tabs 36, 38. In the illustrated example, the optical fiber cable contacts the primary tab 32, causing the primary tab 32 to deflect from its initial position to a deflected position in the direction of arrow 114 toward the mounting base 12 and hanging projection 14.

In FIG. 6, the bent optical fiber cable 110 is illustrated being moved from the hanging projection 14 of the storage hub component 10. As the optical fiber cable 110 is moved by the cable retaining feature 30 in the direction of arrow 120, the optical fiber cable 110 may engage or otherwise come into contact with any one of the primary tabs 32, 34 or secondary tabs 36, 38. In the illustrated example, the optical fiber cable contacts the primary tab 32, causing the primary tab 32 to deflect from its initial position to a deflected position in the direction of arrow 122 away from the mounting base 12.

In some embodiments, the primary tab 32 may be capable of relatively small bend radiuses with a resiliency to return to about the same initial position once the force from the optical fiber cable 110 is removed and also to retain significant amounts of optical fiber cable on the hanging projection 14. In some embodiments, due to the bending of the primary tab 32, the primary tab 32 may have an initial height Hᵢ (with height measured perpendicular to the axis A₂) and a deflected height H_{d} that is at least about 10 percent less, such as at least about 20 percent less, such as at least about 25 percent less, such as at least about 35 percent less, such as at least about 50 percent less than the initial vertical height Hᵢ. In some embodiments, due to any change in thickness of the primary tab 32 along its height, the flexibility of the primary tab 32 may change along its height, such as increase from the tip 96 to the stepped out portion 90. While only primary tab 32 is shown bent in FIGS. 5 and 6, the primary tab 34 (and secondary tabs 36 and 38) may bend in the same or similar manners.

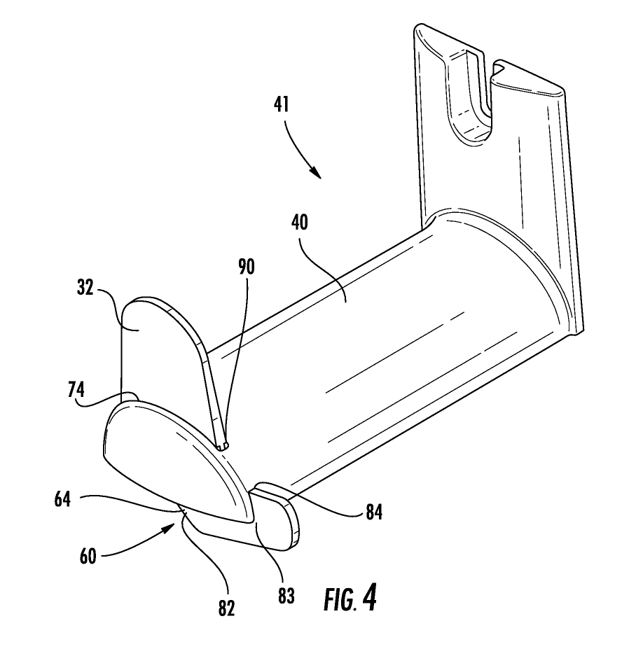

FIGS. 7 and 8 illustrate the storage hub component 10 being used to store optical fiber cable 110 in multiple loops hung around the hanging projection 14, while a minimum bend radius is being maintained by the hanging projection 14. FIG. 8 illustrates a hand 126 manually removing at least some of the optical fiber cable 110 from the hanging projection 14. As the optical fiber cable 110 is moved past the primary tab 32, the primary retaining tab 32 (and any of the other retaining tabs 34, 36 and 38) resiliently bends, as described above to facilitate removal and to make removal more comfortable for the user.

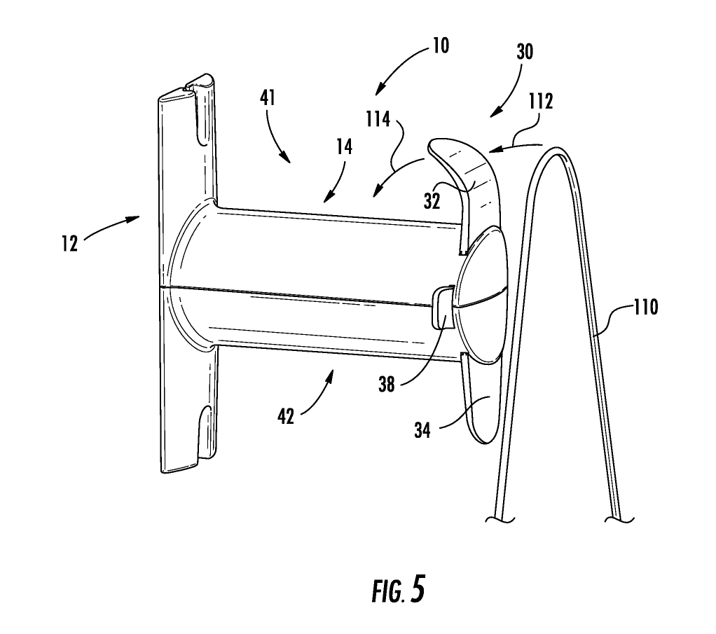

Referring now to FIG. 9, an optical fiber cable management apparatus 150 includes a cable storage housing 152 and multiple ones of the storage hub components 10 mounted therein using their mounting bases 12. As can be seen, the storage hub components 10 are mounted in columns 154 and 156, with storage hub components 10 in column 154 and column 156 being mounted one over the other in a side-by-side vertical arrangement. Referring briefly to FIG. 10, adjacent storage hub components 10a and 10b are illustrated in a side-by-side arrangement with their primary retaining tabs 32a, 34a, 32b and 34b in their initial, undeflected positions. In these initial positions, a distance Dᵢ, measured between tip 90 of primary retaining tab 34a and tip 90 of primary retaining tab 32b is provided. As shown by FIG. 11, deflection of one or both of the primary retaining tabs 34a and 32b increases the distance to a distance D_{d} that is at least about 25 percent or more, such as 50 percent or more, such as 100 percent or more than the distance Dᵢ. While the primary retaining tabs 32b and 34a are illustrated aligned and pointing toward one another, the secondary retaining tabs 36b and 38a may be aligned and point toward one another with the primary retaining tabs 32b and 34a offset 90 degrees, for example.

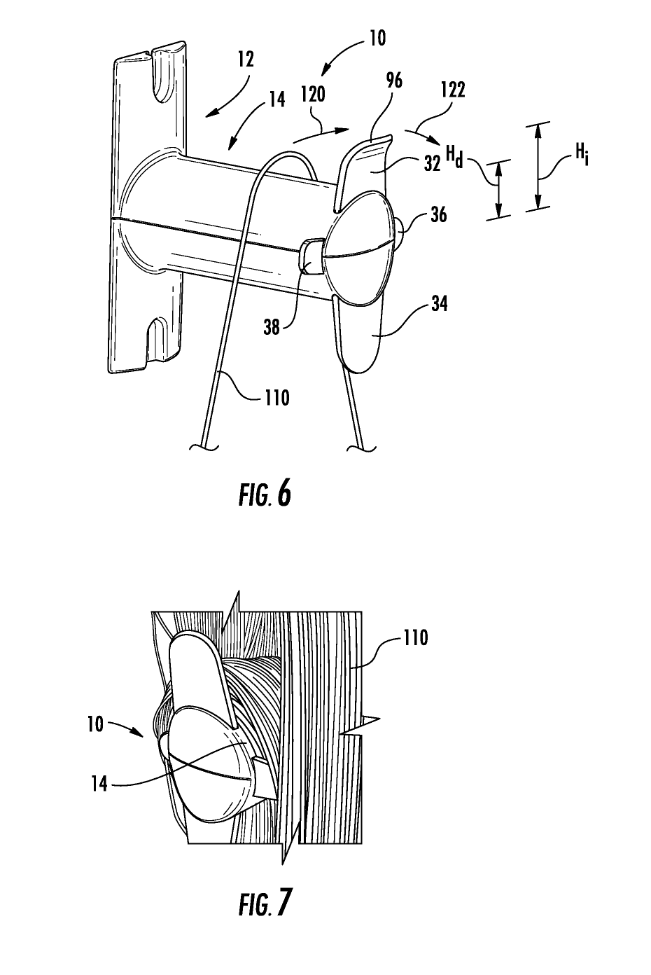

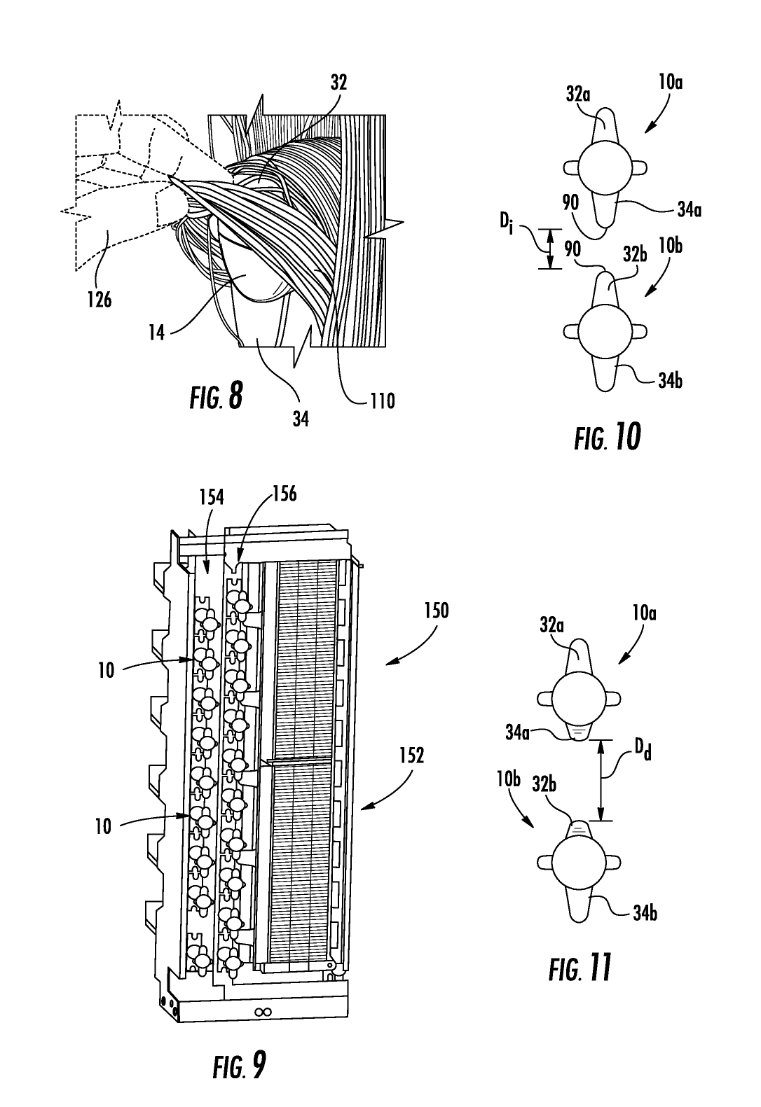

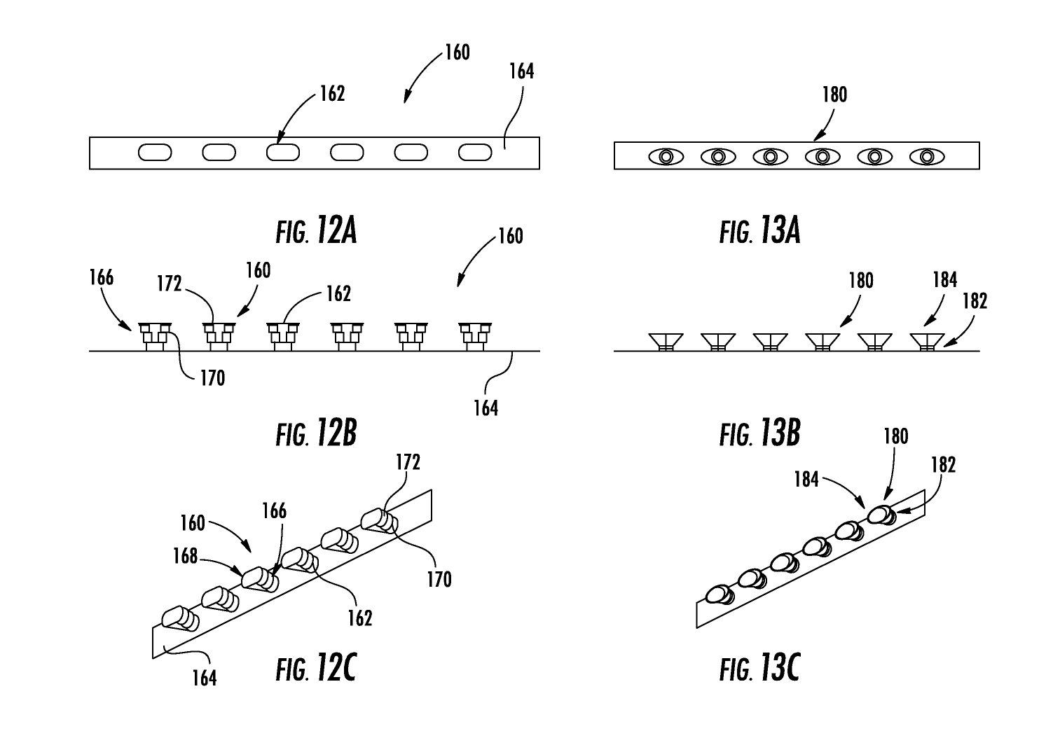

FIGS. 12A-14C illustrate other storage hub component embodiments. Referring first to FIGS. 12A-12C, an array 160 of storage hub components 162 are illustrated mounted to a mounting base 164 (e.g., a flat plate), which can be mounted within a cable storage housing (see FIG. 10). In this embodiment, multiple ones of the storage hub components 162 are mounted to a common mounting base 164. In other embodiments, one or more of the storage hub components 162 may be mounted to separate mounting bases.

Each storage hub component 162 includes a stem portion 166 and an enlarged head portion 168 extending radially from the stem portion 166 such that the head portion 168 overhangs the mounting base 164 at locations adjacent the stem portion 166. The head portion 168 includes stepped regions 170 and 172, each extending radially outwardly from the stem portion 166 at varying dimensions. For example, stepped region 170 may extend outwardly from the stem portion 166 to a first width and stepped region 172 may extend outwardly from the stem portion 166 to a second width that is greater than the first width. Such an increasing width arrangement can facilitate retention of the optical fiber cable, which tends to migrate to an end 176 of the storage hub component 162. FIGS. 13A-13C illustrate a different embodiment including storage hub components 180 that include stem portions 182 and enlarged head portions 184 having increasing widths. In this embodiment, the head portions 184 have a smooth transition of increasing width forming somewhat frustoconical enlarged head portions 184.

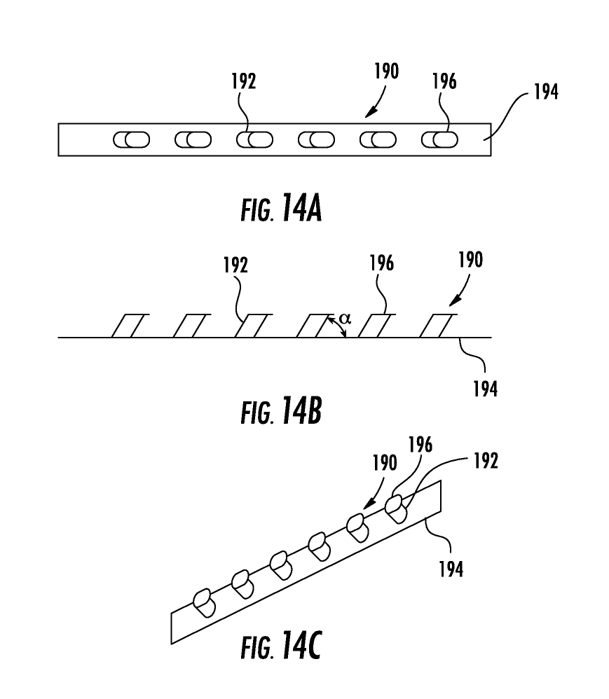

While the stem portions may extend outwardly substantially perpendicular from the mounting base, other arrangements are possible. For example, in FIGS. 14A-14C, stem portions 192 of storage hub components 190 extend outwardly from mounting base 194 at an angle a of less than 90 degrees. The storage hub components 190 also may include enlarged head portions 196. The enlarged head portions 196 and the vertically upward slant of the stem portions 192 can facilitate retention of the optical fiber cable located thereon. In some embodiments, any of the enlarged head portions of FIGS. 12A-14C may include one or more regions having increased flexibility, as described above.

The above-described storage hub components can retain loops of optical fiber cable while facilitating installation and removal thereof by an operator. As storage systems become more and more dense with the storage hub components to retain greater number and lengths of optical fiber cable, flexible retaining tabs are provided to improve access to the stored optical fiber cable and help soften contact between hands and the storage hub components.

As used herein, the terms “optical fiber cables” or “optical fibers” include all types of single mode and multi-mode light waveguides, including one or more optical fibers that may be upcoated, colored, buffered, ribbonized or have other organizing or protective structure in a cable such as one or more tubes, strength members, jackets and the like. Likewise, other types of suitable optical fibers include bend insensitive optical fibers, or any other expedient of a medium for transmitting light signals. An example of a bend insensitive optical fiber is ClearCurve® Multimode fiber, commercially available from Corning Incorporated.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A storage hub component for hanging optical fiber cable comprising:
a mounting base configured to be mounted within a cable storage housing;
a hanging projection extending outwardly from the mounting base, the hanging projection sized to receive loops of optical fiber cable thereon; and
a cable retaining feature comprising a flexible retaining tab extending outwardly from a peripheral surface of the hanging projection, the flexible retaining tab configured to bend upon contact with the optical fiber cable.

2. The storage hub component of claim 1, wherein the cable retaining feature is located at a distal end of the hanging projection.

3. The storage hub component of claim 1, wherein the hanging projection has a retaining slot through the peripheral surface through which the flexible retaining tab extends.

4. The storage hub component of claim 1, wherein the flexible retaining tab is a primary retaining tab, the cable retaining feature further comprising a flexible secondary retaining tab, wherein the secondary retaining tab has a height that is less than the primary retaining tab.

5. The storage hub component of claim 4, wherein the hanging projection has a first retaining slot through the peripheral surface through which the primary retaining tab extends and a second retaining slot through which the secondary retaining tab extends.

6. The storage hob component of claim 4, wherein the secondary retaining tab is offset about 90 degrees from the primary retaining tab.

7. The storage hub component of claim 4 comprising a cable retaining member that includes both of the primary retaining tab and the secondary retaining tab.

8. The storage hub component of claim 7, wherein the cable retaining member is a first cable retaining member and the primary and secondary retaining tabs are first primary and first secondary retaining tabs, the cable retaining feature further comprising a second cable retaining member including a second primary retaining tab that extends outwardly from the peripheral surface of the hanging projection and a second secondary retaining tab that extends outwardly from the peripheral surface of the hanging projection.

9. The storage hub component of claim 1 comprising first and second storage hub component portions that connect together to form the mounting base and the hanging projection.

10. The storage hub component of claim 1, wherein the hanging projection includes a stem portion and an enlarged head portion extending outwardly from the stem portion.

11. An optical fiber cable management apparatus comprising:
a cable storage housing; and
a plurality of storage hub components mounted within the cable storage housing, each storage hub component comprising:
a mounting base configured to be mounted within the cable storage housing;
a hanging projection extending outwardly from the mounting base, the hanging projection sized to receive loops of optical fiber cable thereon; and
a cable retaining feature comprising a flexible retaining tab extending outwardly from a peripheral surface of the hanging projection, the flexible retaining tab configured to bend upon contact with the optical fiber cable.

12. The apparatus of claim 11, wherein the cable retaining feature of each storage hub component is located at a distal end of the hanging projection.

13. The apparatus of claim 11, wherein the hanging projection of each storage hub component has a retaining slot through the peripheral surface through which the flexible retaining tab extends.

14. The apparatus of claim 11, wherein the flexible retaining tab of each storage hub component is a primary retaining tab, the cable retaining feature of each storage hub component further comprising a flexible secondary retaining tab, wherein the secondary retaining tab has a height that is less than the primary retaining tab.

15. The apparatus of claim 14, wherein the hanging projection of each storage hub component has a first retaining slot through the peripheral surface through which the primary retaining tab extends and a second retaining slot through which the secondary retaining tab extends.

16. The apparatus of claim 14, wherein the secondary retaining tab of each storage hub component is offset about 90 degrees from the primary retaining tab.

17. The apparatus of claim 14, wherein each storage hub component comprises a cable retaining member that includes both of the primary retaining tab and the secondary retaining tab.

18. The apparatus of claim 17, wherein the cable retaining member of each storage hub component is a first cable retaining member and the primary and secondary retaining tabs are first primary and first secondary retaining tabs, the cable retaining feature of each storage hub component further comprising a second cable retaining member including a second primary retaining tab that extends outwardly from the peripheral surface of the hanging projection and a second secondary retaining tab that extends outwardly from the peripheral surface of the hanging projection.

19. The apparatus of claim 11, wherein each storage hub component comprises first and second storage hub component portions that connect together to form the mounting base and the hanging projection.

20. The apparatus of claim 11, wherein the hanging projection of each storage hub component includes a stem portion and an enlarged head portion extending outwardly from the stem portion.

21. A method of managing optical fiber cable using a cable management apparatus including a cable storage housing and multiple storage hub components mounted within the cable storage housing, the method comprising:
providing a storage hub having a hanging projection with a flexible retaining tab extending outwardly from a peripheral surface of the hanging projection; and
bending the flexible retaining tab from an initial, upright position toward the hanging projection providing increased spacing to place the optical fiber cable about the hanging projection.

22. The method of claim 21, wherein the bending the flexible retaining tab is by the optical fiber engaging the flexible retaining tab.

23. The method of claim 21, wherein the increased space is between the flexible retaining tab and an adjacent storage hub component.

24. The method of claim 21, wherein after bending the flexible retaining tab, the flexible retaining tab returning to the initial, upright position thereby retaining the optical fiber cable on the hanging projection.
